(19) United States
(12) Patent Application Publication
(10) Pub. No.: US 2026/0329740 A1
(43) Pub. Date: Oct. 22, 2026

(54) CODE TESTING METHOD, DEVICE, AGENT, AND STORAGE MEDIUM

(71) Applicant: Beijing Baidu Netcom Science Technology Co., Ltd., Beijing (CN)

(72) Inventors: Jingjing WU, Beijing (CN); Sijun HE, Beijing (CN); Siqi BAO, Beijing (CN); Bingjin CHEN, Beijing (CN); Jingzhou HE, Beijing (CN)

(21) Appl. No.: 19/712,870

(22) Filed: Jun. 18, 2026

(30) Foreign Application Priority Data
Mar. 23, 2026 (CN) 202610360221.2

(51) Int. Cl. G06F 11/3668

(52) U.S. Cl. CPC G06F 11/3692; G06F 11/3684; G06F 11/3688

(57) ABSTRACT

A code testing method, a device, an agent, and a storage medium are provided, and relate to a field of artificial intelligence technology, and in particular to the fields of large models, intelligent agents, and software engineering technology. The code testing method includes: analyzing, using an analysis agent, an information of a code to be tested to obtain an environment requirement information, where the environment requirement information indicates a configuration requirement for constructing a test environment for the code to be tested, the configuration requirement matching a programming language of the code to be tested; constructing the test environment based on the environment requirement information; and executing a test on the code to be tested in the test environment to obtain a test result, where the test result indicates a running status of the code to be tested in a valid test environment.

This application claims the benefit of priority to Chinese Patent Application No. 202610360221.2, filed on Mar. 23, 2026. The entire contents of this application are hereby incorporated herein by reference.

### TECHNICAL FIELD

The present disclosure relates to a field of artificial intelligence technology, and in particular to the fields of large models, intelligent agents, and software engineering technology, and more specifically, the present disclosure relates to a code testing method, a device, an agent, and a storage medium.

### BACKGROUND

With the deep application of large language models in the software engineering field, tasks such as code repository retrieval and code repair in the software engineering field may be accomplished based on large language models. However, the test environments used to run these tasks still rely heavily on expert experience, easily falling into a blind cycle of environment construction and exploratory iteration, making it difficult to construct a valid environment on which the code to be tested depends.

### SUMMARY

The present disclosure provides a code testing method, a device, an agent, and a storage medium.

According to an aspect of the present disclosure, there is provided a code testing method, including: analyzing, using an analysis agent, an information of a code to be tested to obtain an environment requirement information, where the environment requirement information indicates a configuration requirement for constructing a test environment for the code to be tested, the configuration requirement matching a programming language of the code to be tested; constructing the test environment based on the environment requirement information; and executing a test on the code to be tested in the test environment to obtain a test result, where the test result indicates a running status of the code to be tested in a valid test environment.

According to another aspect of the present disclosure, there is provided an agent for code testing, including: an input module configured to receive an information of a code to be tested; a processing module configured to determine a target task based on the information of the code to be tested received by the input module, determine a target large model based on the target task, and execute the aforementioned code testing method by invoking the target large model to obtain a test result; and an output module configured to output the test result obtained by the processing module.

According to another aspect of the present disclosure, there is provided an electronic device, including: at least one processor; and a memory communicatively connected to the at least one processor described above, where the memory stores instructions executable by the at least one processor, and the instructions, when executed by the at least one processor, are configured to cause the at least one processor to implement the method described above.

According to another aspect of the present disclosure, there is provided a non-transitory computer-readable storage medium having computer instructions therein, where the computer instructions are configured to cause a computer to implement the method described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 schematically shows an exemplary system architecture in which a code testing method and an apparatus may be applied according to an embodiment of the present disclosure;

FIG. 2 schematically shows a flowchart of a code testing method according to an embodiment of the present disclosure;

FIG. 3 schematically shows a schematic diagram of automatically constructing a test environment according to an embodiment of the present disclosure;

FIG. 4 schematically shows a schematic diagram of an environment constructing agent self-correcting instructions in a constructing process according to an embodiment of the present disclosure;

FIG. 5 schematically shows a schematic diagram of multi-agent interaction to construct a valid test environment according to an embodiment of the present disclosure;

FIG. 6 schematically shows a schematic diagram of running a test configuration script in a constructed test environment to verify whether the test environment has a deficiency according to an embodiment of the present disclosure;

FIG. 7 schematically shows a schematic diagram of an environment reuse mechanism according to an embodiment of the present disclosure;

FIG. 8 schematically shows a block diagram of a code testing apparatus according to an embodiment of the present disclosure;

FIG. 9 schematically shows a block diagram of an agent for code testing according to an embodiment of the present disclosure; and

FIG. 10 schematically shows a block diagram of an electronic device suitable for implementing a code testing method according to an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skill in the art should realize that various changes and modifications may be made to the embodiments described herein without departing from the scope and spirit of the present disclosure. Likewise, for clarity and conciseness, descriptions of well-known functions and structures are omitted in the following description.

In related examples, test environments are usually constructed based on expert experience, which easily falls into a blind cycle of environment construction and exploratory iteration, making it difficult to fully construct complex environment dependencies.

In view of the above, embodiments of the present disclosure analyze an information of a code to be tested using an analysis agent, so as to obtain a configuration requirement for constructing a test environment for the code to be tested that match a programming language of the code to be tested, and based on the configuration requirement, may quickly construct a valid test environment for code testing, at least solving the problem in related examples that it is difficult to construct complete complex environment dependencies due to the lack of comprehensive analysis of the information of the code to be tested and environment operation planning, further improving the efficiency of test environment construction and testing.

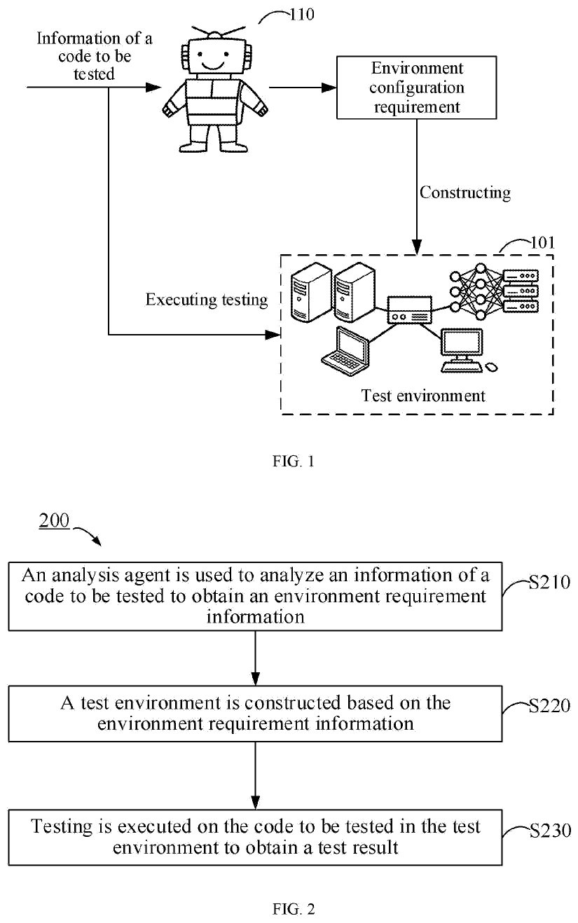

FIG. 1 schematically shows an exemplary system architecture in which a code testing method and a code testing apparatus may be applied according to an embodiment of the present disclosure.

It should be noted that FIG. 1 is only an example of a system architecture to which embodiments of the present disclosure may be applied, to help those skilled in the art understand the technical content of the present disclosure, but does not mean that embodiments of the present disclosure may not be used in other devices, systems, environments, or scenarios. For example, in another embodiment, an exemplary system architecture in which a code testing method and an apparatus may be applied may include a terminal device, but the terminal device may implement the code testing method and the apparatus provided by embodiments of the present disclosure without interacting with a server.

As shown in FIG. 1, a system architecture 100 according to the embodiment may include: an analysis agent 110. The information of the code to be tested may originate from a code repository. A code repository is a digital carrier dedicated to centrally storing and managing all code and related ancillary files of the project to which the code to be tested belongs. Related ancillary files may include, for example, configuration files, project documents, construct scripts, static resources, etc.

The analysis agent 110 may traverse various file information in the target code repository corresponding to the code to be tested to obtain an analysis report. The analysis report at least includes functional description information of the project to which the code to be tested belongs, programming language environment information used in developing the code to be tested, dependency package information related to the programming environment, file structure information of the project, unit test execution method information, etc.

Environment configuration requirements may at least include programming language environment information and dependency package information related to the programming environment.

Since the environment configuration requirements are obtained by analyzing the information of the code to be tested, compared with expert subjective experience, they may provide an objective basis for the selection of the basic environment at the initial stage of test environment construction, and provide an effective direction for the retrieval of key information for environment installation during the exploratory iteration cycle, thereby further improving the efficiency of automatically constructing the test environment.

Based on the environment configuration requirements, a valid test environment 101 for code testing may be quickly constructed, so as to execute a test on the code to be tested in the test environment, obtaining a result that indicates the running status of the code to be tested in the valid test environment.

FIG. 2 schematically shows a flowchart of a code testing method according to an embodiment of the present disclosure.

As shown in FIG. 2, a method 200 includes operations S210 to S230.

In operation S210, an analysis agent is used to analyze an information of a code to be tested to obtain an environment requirement information.

In operation S220, a test environment is constructed based on the environment requirement information.

In operation S230, a test is executed on the code to be tested in the test environment to obtain a test result.

The information of the code to be tested may refer to code repository information of the project to which the code to be tested belongs. The code repository information may at least include: all code and related ancillary files of the project to which the code to be tested belongs, such as configuration files, project documents, construct scripts, static resources, etc.

The analysis agent may be a large language model used to perform a code repository analysis task. For example, a prompt for performing a code repository analysis task may be preconfigured, and the prompt may include reference information obtained by analyzing a reference code repository to obtain reference environment requirements, so that the analysis agent may refer to the analysis process in the prompt to comprehensively analyze the information of the code to be tested in the direction of test environment planning and construction, further improving the success rate of constructing a valid test environment.

For example, analyzing information of code to be tested by using an analysis agent may obtain programming language environment information and dependency package information related to the programming environment.

In embodiments of the present disclosure, key information for constructing a test environment, such as programming language environment information and dependency package information related to the programming environment, is referred to as environment requirement information. The environment requirement information indicates a configuration requirement for constructing a test environment for the code to be tested, the configuration requirement matching the programming language of the code to be tested.

Embodiments of the present disclosure may support various programming languages, for example, more than ten mainstream programming languages such as Python, Go, and Java, and may adapt to different testing requirements to construct a rich variety of test environments.

In some embodiments, the environment requirement information may also indicate base image version information in configuration files of the project to which the code to be tested belongs. For example, Python base image information is stored in a setup.py configuration file. Java base image information is stored in a pom. xml file.

Therefore, the analysis agent may retrieve base image version information from the information of the code to be tested based on the programming language type. When the configuration file contains a plurality of base image versions, because higher-version image data have better compatibility, a higher-version image data may be preferentially selected as the base image, further improving the success rate of constructing the test environment.

Although the environment requirement information already provides key configuration requirement information for constructing the test environment, the construction may still fail during test environment construction due to issues such as missing dependencies or image version conflicts.

In some embodiments, before constructing the test environment, the analysis agent may also be used to verify whether there are issues of missing dependencies or image version conflicts for the generated environment requirement information, thereby overcoming potential problems that may arise in the constructing process in advance in the planning phase, further improving the efficiency of test environment construction.

After constructing the test environment, the code to be tested may be run in the constructed test environment to verify whether the environment configuration is correct and valid. When running the code to be tested in the constructed test environment fails, it may be due to missing environment dependencies or incorrect test instructions.

In some embodiments, when a test fails, the reason of failure may be determined through attribution analysis. When it is determined that the test fails due to missing environment dependencies, the test environment may be reconstructed, or the constructed test environment may be corrected based on the failure reason, until a valid test environment is obtained.

Executing a test on the code to be tested in a valid test environment yields a test result that indicates the running status of the code to be tested in the valid test environment.

Embodiments of the present disclosure analyze an information of a code to be tested using an analysis agent, so as to obtain a configuration requirement for constructing a test environment for the code to be tested that match a programming language of the code to be tested, and based on the configuration requirements, may quickly construct a valid test environment for code testing, at least solving the problem in related examples that it is difficult to construct complete complex environment dependencies due to the lack of comprehensive analysis of the information of the code to be tested and environment operation planning, further improving the efficiency of test environment construction and testing.

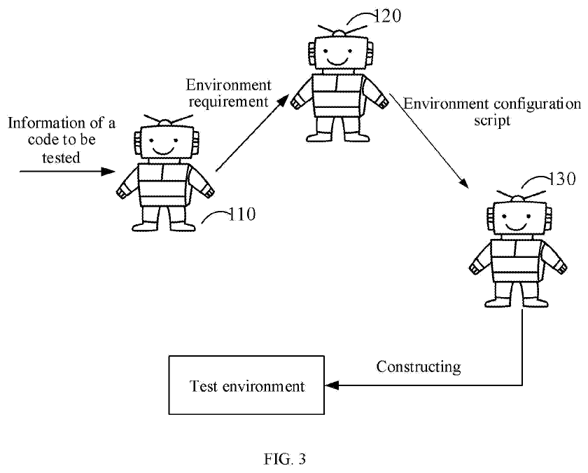

A specific embodiment of the above-mentioned operation S220 is described in detail below with reference to FIG. 3.

According to embodiments of the present disclosure, the constructing the test environment based on the environment requirement information may include the following operations: generating, using an environment configuration agent, an environment configuration script based on the environment requirement information; and constructing, using an environment constructing agent, the test environment by running the environment configuration script.

FIG. 3 schematically shows a schematic diagram of automatically constructing a test environment according to an embodiment of the present disclosure.

As shown in FIG. 3, an environment configuration agent 120 may generate an environment configuration script based on environment requirement information.

The environment configuration agent 120 may be a large language model for performing an environment configuration script generation task. For example, a prompt for performing an environment configuration script generation task may be preconfigured, and the prompt may include reference information for generating a reference environment configuration script based on reference environment requirements, so that the environment configuration agent may refer to the generation process in the prompt to generate an environment configuration script for constructing the test environment.

In some embodiments, the environment configuration script may include a plurality of initial instructions to be executed for constructing the test environment. These initial instructions to be executed may be installation instructions to be executed for environment dependency packages when constructing the test environment. These installation instructions may be retrieved from the information of the code to be tested, for example, a requirements. txt file for Python, a pom. xml file for Java, etc.

The environment configuration agent 120 will send the environment configuration script to an environment constructing agent 130. The environment constructing agent 130 is mainly used to run the plurality of initial instructions to be executed in the environment configuration script, install environment dependency packages, and thereby construct the test environment.

The environment constructing agent 130 may determine, based on the environment requirement information, a container launched from an image matching the programming language environment, then install dependency packages in the container by running the plurality of initial instructions to be executed in the environment configuration script, thereby constructing the test environment.

Since the environment configuration script is generated based on the environment requirements, compared with expert subjective experience, it may provide an objective basis for the selection of the basic environment at the initial stage of test environment construction, and provide an effective direction for the retrieval of key information for environment installation during the exploratory iteration cycle, thereby further improving the efficiency of automatically constructing the test environment.

In some embodiments, in the process of constructing the test environment, the execution of initial instructions to be executed may fail for various reasons. Therefore, by monitoring the execution status of the initial instructions to be executed in real time and dynamically adjusting the initial instructions to be executed, the smoothness of the test environment construction process may be further improved.

In embodiments of the present disclosure, the constructing, using an environment constructing agent, the test environment by running the environment configuration script may include the following operations: executing, using the environment constructing agent, the plurality of initial instructions to be executed; correcting, using the environment constructing agent, at least one of the plurality of initial instructions to be executed, in response to detecting that execution of any one of the plurality of initial instructions to be executed fails; and constructing, using the environment constructing agent, the test environment by executing at least one corrected instruction to be executed.

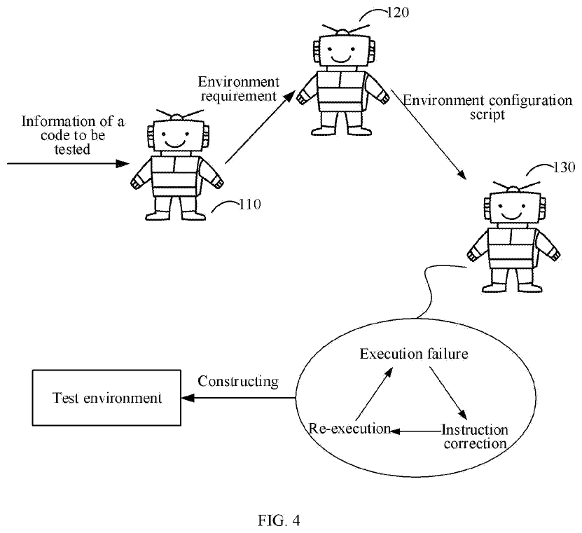

FIG. 4 schematically shows a schematic diagram of an environment constructing agent self-correcting instructions in a constructing process according to an embodiment of the present disclosure.

As shown in FIG. 4, the environment constructing agent 130 may monitor the execution status of each initial instruction to be executed in real time. The execution status indicates whether the initial instruction to be executed was executed successfully, and the reason for the successful or failed execution of the initial instruction to be executed. These reasons may include, for example, image version conflicts.

Since image version information is stored in configuration files in the code repository, when an image version conflict occurs, the environment constructing agent may dynamically adjust the initial instructions to be executed based on the failure reason, for example, correcting an instruction to install version V2.0 of an environment dependency package to an instruction to install version V1.0 of the environment dependency package.

Then, the test environment may be constructed by executing the corrected instructions to be executed. In the instruction correction process, a plurality of cycles of interaction may occur, for example: when the execution of the instruction to be executed fails, the instruction is corrected, and then the corrected instruction is re-executed. This continues until all instructions to be executed are executed successfully, completing the test environment construction.

Using the self-correction capability of the environment constructing agent, the initial instructions to be executed may be dynamically adjusted by monitoring the execution status of the initial instructions to be executed in real time in the test environment construction process, further improving the smoothness of the test environment construction process.

In some embodiments, a maximum number of interaction cycles may be set to prevent the environment constructing agent from performing a plurality of ineffective corrections that could affect the construction process.

For example, if re-executing the corrected instructions within the maximum number of interaction cycles successfully completes the test environment construction, then the testing phase proceeds. If the maximum number of interaction cycles is reached and re-executing the corrected instructions still fails, it indicates that the reason of the environment construct failure may not be corrected by the environment constructing agent itself. At this point, it is necessary to return to the planning phase, re-analyze the reason of the environment failure, and regenerate the environment configuration script.

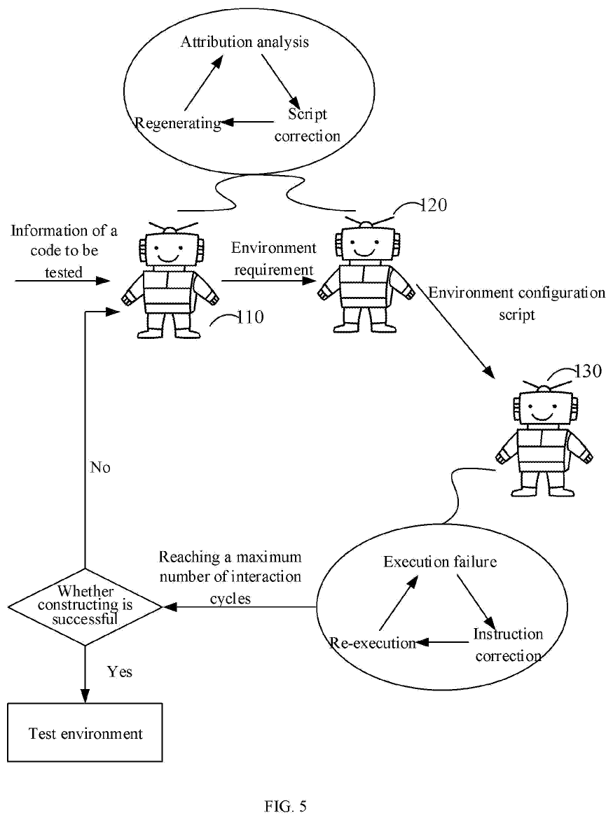

FIG. 5 schematically shows a schematic diagram of multi-agent interaction to construct a valid test environment according to an embodiment of the present disclosure.

As shown in FIG. 5, when the environment constructing agent 130 reaches the maximum number of interaction cycles, it is determined whether the test environment is successfully constructed. If the construction still fails, the analysis agent 110 and the environment configuration agent 120 need to cooperate to correct the environment configuration script.

In some embodiments, the constructing, using the environment constructing agent 130, the test environment by running the environment configuration script may further include the following operations: performing, using the analysis agent 110, attribution analysis on a first log of the environment configuration script during runtime of the environment configuration script to obtain a first failure reason, in response to detecting that construction of the test environment fails; correcting, using the environment configuration agent 120, the environment configuration script based on the environment requirement information and the first failure reason; and running, using the environment constructing agent 130, the corrected environment configuration script to construct the test environment.

The first log may be a log collected by the environment constructing agent 130 during runtime of the initial environment configuration script. The initial environment configuration script may be generated by the environment configuration agent 120 based on the environment requirement information. Since the environment constructing agent 130 has undergone a plurality of self-corrections without resolving the test environment construct failure, the attribution analysis is performed on the log of the original environment configuration script during runtime of the original environment configuration script, which may reduce the interference with the attribution analysis results caused by redundant information introduced in the self-correction process of the environment constructing agent 130.

For example, by performing attribution analysis on the first log of the environment configuration script during runtime of the environment configuration script using the analysis agent 110, the obtained first failure reason may be that no corresponding executable installation data package was found during installation for the instruction to be executed “pip install wechaty==0.1.6”.

Using the environment configuration agent 120, the instruction to be executed in the environment configuration script is corrected to “pip install wechaty>=0.1.6.” based on the environment requirement information and the first failure reason.

Then, when running the corrected environment configuration script by using the environment constructing agent 130, an environment dependency package with a version greater than 0.1.6 may be installed, thereby further improving the robustness of environment dependency package installation in the test environment construction process.

In some embodiments, the environment constructing agent 130 may have already fixed some issues in its self-correction process. Therefore, the constructing, using the environment constructing agent, the test environment by running the environment configuration script may further include the following operations: performing, using the analysis agent, attribution analysis on a second log of the corrected environment configuration script during runtime of the corrected environment configuration script to obtain a second failure reason, in response to detecting that construction of the test environment based on the corrected environment configuration script fails; correcting, using the analysis agent, the environment requirement information based on the second failure reason and the information of the code to be tested; and generating, using the environment configuration agent, a to-be-run environment configuration script based on the corrected environment requirement information.

The second log may be a log collected by the environment constructing agent 130 during runtime of the corrected environment configuration script. The corrected environment configuration script may be obtained by the environment constructing agent 130 self-correcting the instructions to be executed during runtime of the initial environment configuration script.

In some embodiments, the corrected environment configuration script may be secondarily corrected based on the second failure reason first. If execution based on the secondarily corrected environment configuration script still fails, then it is possible to trace back to the initial environment requirement analysis phase and use the analysis agent to correct the environment requirement information.

In order to improve the accuracy of the agent's analysis, when the analysis agent 110 re-analyzes the environment requirements, it may comprehensively analyze the information of the code to be tested and perform environment operation planning based on the second failure reason and the information of the code to be tested. In the analysis and planning process, special attention is paid to the second failure reason to reduce the probability of another test environment construct failure.

For example, when performing analysis, the analysis agent 110 may focus on retrieving configuration files related to the second failure reason from the information of the code to be tested, extract key information related to constructing the test environment, and send it to the environment configuration agent 120, so that the environment configuration agent may generate a to-be-run environment configuration script based on the key information, fundamentally reducing the probability of execution failure of the to-be-tested instructions.

When performing attribution analysis, the second log of the corrected environment configuration script during runtime of the corrected environment configuration script is analyzed, thereby reducing redundant correction operations on the corrected commands.

In order to verify the effectiveness of the constructed test environment, in embodiments of the present disclosure, the executing a test on the code to be tested in the test environment to obtain a test result may include the following operations: generating, using a test configuration agent, a test configuration script based on the code structure information and the environment configuration script; and executing, using a test execution agent, the test on the code to be tested in the test environment by running the test configuration script, so as to obtain the test result.

The information of the code to be tested includes code structure information, and the code structure information may be stored in project file structure information in the code repository.

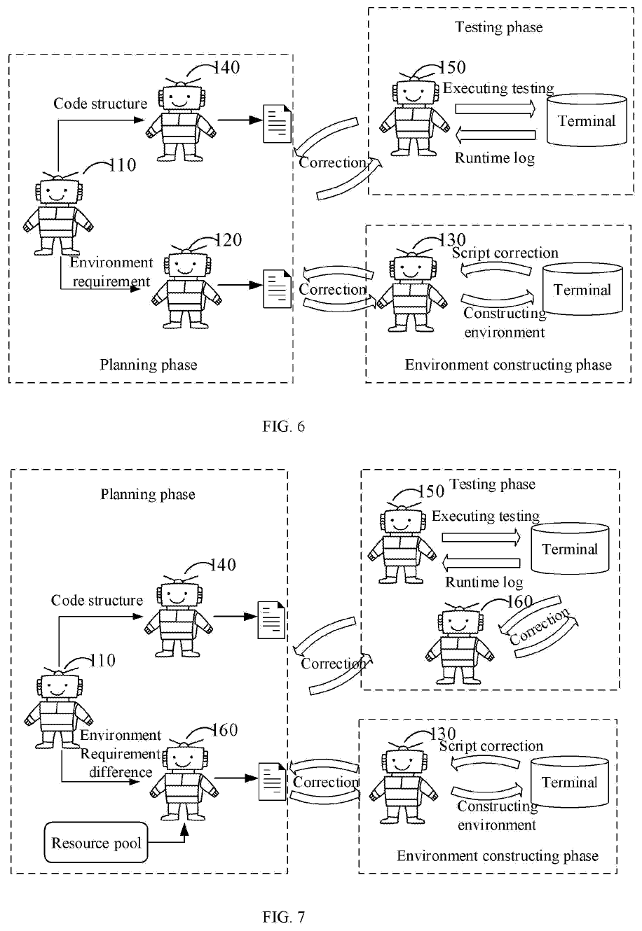

A specific embodiment of the operation S230 described above is explained in detail below with reference to FIG. 6.

FIG. 6 schematically shows a schematic diagram of running a test configuration script in a constructed test environment to verify whether the test environment has a deficiency according to an embodiment of the present disclosure.

As shown in FIG. 6, in the planning phase, the analysis agent 110 may be used to analyze the information of the code to be tested to obtain code structure information. Then, the code structure is sent to the test configuration agent 140 to generate a test configuration script.

The test configuration script may include a plurality of initial test instructions for the code to be tested. Unlike the process of generating an environment configuration script, the test configuration agent 140 needs to retrieve test-related configuration files from the information of the code to be tested based on the code structure, and combine them with the environment configuration script to generate a test configuration script that may be executed in a preconfigured test environment.

In the planning phase, the environment configuration agent 120 is used to generate an environment configuration script based on the environment requirement information. The relevant operations of constructing, using the environment constructing agent 130, the test environment by running the environment configuration script in the environment constructing phase have been described above and will not be described in detail here.

Moreover, as the test configuration script may only be run in the test environment, when the test configuration script is generated, the execution of the plurality of initial test instructions in the test configuration script is allowed when the test environment is successfully constructed.

Finally, in the testing phase, the test execution agent 150 is used to run the test configuration script in the test environment constructed on the terminal, thereby executing the test on the code to be tested and obtaining the test result.

The test configuration agent, by combining the environment configuration script, generates a test configuration script that may be executed in the preconfigured test environment, which further improves the consistency between the environment configuration logic and the test verification logic.

According to embodiments of the present disclosure, the executing, using a test execution agent, the test on the code to be tested in the test environment by running the test configuration script, so as to obtain the test result may include the following operations: executing, using the test execution agent, the plurality of initial test instructions; correcting, using the test execution agent, at least one of the plurality of initial test instructions, in response to detecting that execution of any one of the plurality of initial test instructions fails; and obtaining, using the test execution agent, the test result by executing at least one corrected test instruction.

As shown in FIG. 6, the test execution agent 150 may monitor the execution status of each initial test instruction in real time. The execution status indicates whether the initial test instruction was executed successfully, and the reason for the successful or failed execution of the initial instruction to be executed. These reasons may include, for example, test instruction conflicts.

The test execution agent 150 may be a large model for executing test instructions, and may be preconfigured with a reference prompt to give the test execution agent the ability to self-correct test instructions. For example, when a test instruction conflict is monitored, the execution order of a plurality of test instructions may be adjusted automatically.

Then, the test on the code to be tested may be completed by executing the corrected test instructions. In the instruction correction process, a plurality of cycles of interaction may occur, for example: when the execution of the instruction to be executed fails, the instruction is corrected, and then the corrected instruction is re-executed. This continues until all test instructions are executed successfully, completing the test.

Using the self-correction capability of the test execution agent, the initial test instructions are dynamically adjusted by monitoring the execution status of the initial test instructions in real time in the testing process, to verify whether the constructed test environment meets the testing requirements.

In some embodiments, a maximum number of interaction cycles may be set to prevent the test execution agent from performing a plurality of ineffective corrections that could affect the testing process.

For example, re-executing the corrected test instructions within the maximum number of interaction cycles may successfully complete the test. If the maximum number of interaction cycles is reached and re-executing the corrected test instructions still fails, it indicates that the reason of the test failure may not be corrected by the test execution agent itself. In this case, it is necessary to return to the planning phase and re-analyze the reason of the test failure.

According to embodiments of the present disclosure, the executing, using a test execution agent, the test on the code to be tested in the test environment by running the test configuration script, so as to obtain the test result may include the following operations: analyzing, using the analysis agent, a third log of the plurality of initial test instructions during runtime of the plurality of initial test instructions to obtain a third failure reason, in response to the test result indicating a test failure; correcting, using the environment configuration agent, the environment configuration script based on the third failure reason, in response to the third failure reason indicating a test environment deficiency; updating, using the environment constructing agent, the test environment based on the corrected environment configuration script; and running, using the test execution agent, the test configuration script in the updated test environment.

As shown in FIG. 6, when a test fails, the third log may be a log collected by the test execution agent 150 during runtime of the initial test instructions. The initial test instructions may be generated by the test configuration agent 140 based on the environment requirement information and the corrected environment configuration script. The corrected environment configuration script may represent the environment configuration script associated with the currently constructed test environment.

Since the test execution agent 150 has undergone a plurality of self-corrections without resolving the test failure, the attribution analysis is performed on the log of the initial test configuration script associated with the currently constructed test environment during runtime of the initial test configuration script, which may reduce the interference with the attribution analysis results caused by redundant information introduced in the self-correction process of the test execution agent 150.

In related examples, due to the lack of verification of the constructed test environment during test execution, when a test fails, it is impossible to determine whether the reason of the failure lies in the environment configuration or the test configuration.

Therefore, in embodiments of the present disclosure, when the analysis agent 110 performs attribution analysis on the third log, it may accurately determine the root reason of the test failure, so as to adjust the configuration script in a targeted manner based on the root reason.

When it is determined that the reason of the test failure is a test environment deficiency, for example, a certain environment dependency package is not installed, or an installed environment dependency package does not match the test instructions, the process may return to the planning phase with the environment configuration agent 120 to correct the environment configuration script based on the third failure reason. Then, the environment constructing agent 130 is used to update the test environment based on the corrected environment configuration script.

In the test environment update process, if it is monitored that any installation instruction in the environment configuration script cannot be executed properly, the environment constructing agent 130 may still be used to self-correct the installation instruction until the test environment construction is completed. This construction process is the same as the first construction of the test environment and will not be described in detail here.

When the test environment is successfully updated, the testing phase is entered again, and the test execution agent 150 is used to execute the test configuration script. In the testing phase, the test configuration script that failed in the last execution may be selected to be executed to verify the reconstructed test environment.

In some embodiments, the running, using the test execution agent, the test configuration script in the updated test environment may further include the following operations: generating, using the test configuration agent, a target test configuration script based on the corrected environment configuration script and the code structure information; and running, using the test execution agent, the target test configuration script in the updated test environment.

For example, the test configuration agent 140 may be used to regenerate a test configuration script based on the corrected environment configuration script and the code structure information, i.e., a target test configuration script, to ensure consistency between the verification logic and the environment logic. Then, the test execution agent 150 is used to run the target test configuration script in the reconstructed test environment.

When it is determined that the reason of the test failure is a test environment deficiency, the test environment is re-planned based on the failure reason, which solves the ineffective cycles caused by blind exploratory iteration at the root, provides clear guidance for constructing the test environment, and further improves the efficiency of constructing a valid test environment.

When it is determined that the reason of the test failure is a test instruction error, it indicates that the currently constructed test environment is valid, but there are instruction conflicts among the plurality of test instructions in the test configuration script generated by the test configuration agent, leading to test failure. Such instruction conflicts may be caused by a mismatch with the currently constructed test environment. Therefore, what needs to be corrected at this point is the test configuration script.

According to embodiments of the present disclosure, the executing, using a test execution agent, the test on the code to be tested in the test environment by running the test configuration script, so as to obtain the test result may further include the following operations: correcting, using the test configuration agent, the test configuration script based on the third failure reason, in response to the third failure reason indicating a test instruction error; and running, using the test execution agent, the corrected test configuration script in the test environment, so as to obtain the test result.

As shown in FIG. 6, the test configuration agent 140 may be used to correct the test configuration script based on the third failure reason, so as to improve the matching degree between the test instructions in the corrected test configuration script and the constructed test environment.

In some embodiments, the third failure reason, the code structure information, the test configuration script, and the environment configuration script associated with the constructed test environment may be used as input to the test configuration agent 140, so that the test configuration agent 140 may determine the correction direction based on the third failure reason and make targeted corrections to the test configuration script according to the correction direction, further improving correction efficiency and reducing the number of interactions between agents.

Then, the test execution agent 150 is used to run the corrected test configuration script in the constructed test environment to obtain the test result.

In some embodiments, the process of correcting the test configuration script may also be performed in a plurality of cycles until all test instructions in the test configuration script are executed successfully.

In some embodiments, a maximum number of interaction cycles may also be set for the process of correcting the test configuration script or the environment configuration script. If the maximum number of interaction cycles is reached and the test still fails, the process may return to the phase in the planning phase where the analysis agent generates the environment configuration requirements, and regenerate the environment configuration requirements based on the failure reason.

Based on the collaborative interaction among a plurality of agents, the test instructions are dynamically adjusted according to the feedback logs, further improving the efficiency of verifying the test environment, thereby enabling the rapid and automatic construction of a valid test environment.

In related examples, for any test scenario, the test environment is constructed from scratch, which is not only time-consuming but also reduces the reuse rate of available resources.

Therefore, in embodiments of the disclosure, historical environment configuration scripts corresponding to valid test environments that have been verified by testing may be stored in a resource pool. When a test environment needs to be constructed, a historical environment configuration script that matches the environment requirement information may be acquired; the historical environment configuration script is corrected to obtain a target environment configuration script that matches the environment requirement information; and the test environment is constructed based on the target environment configuration script.

FIG. 7 schematically shows a schematic diagram of an environment reuse mechanism according to an embodiment of the present disclosure.

As shown in FIG. 7, the difference between the embodiment and the embodiment shown in FIG. 6 is that an environment correction agent 160 is used to replace the environment configuration agent 120, so as to correct the historical environment configuration script.

In some embodiments, the correcting the historical environment configuration script to obtain a target environment configuration script matching the environment requirement information may include the following operations: analyzing, using the analysis agent, historical code information associated with the historical environment configuration script and the information of the code to be tested, to obtain environment requirement difference information; and correcting, using an environment correction agent, the historical environment configuration script based on the environment requirement difference information to obtain the target environment configuration script.

As shown in FIG. 7, first, the analysis agent 110 may be used to analyze the environment requirement differences between the historical code information and the information of the code to be tested. Then, the environment correction agent 160 is used to correct the historical environment configuration script based on the environment requirement differences. As the historical environment configuration script has already successfully constructed a valid test environment, the parts of the previously constructed valid test environment that are the same as the current environment requirements may be reused, reducing the probability of correcting the environment configuration script in the environment construction process.

Furthermore, by correcting the historical environment configuration script based on the environment requirement differences, even if issues arise in the subsequent environment construction process where certain installation instructions cannot be executed, only the instructions in the differential script need to be corrected. Compared to constructing a test environment from scratch, the number of instructions requiring correction is also reduced. Therefore, compared to an environment configuration script generated when constructing a test environment from scratch, the target environment configuration script further improves the success rate of constructing a valid test environment and increases the utilization rate of historically available resources.

Adopting the environment reuse mechanism does not completely guarantee a smooth testing phase, and the possibility of test failure still exists.

Therefore, the analysis agent is used to analyze a fourth log of the code to be tested during runtime of the code to be tested to obtain a fourth failure reason, in response to the test result indicating a test failure.

The fourth log is collected when running the code to be tested in the test environment constructed based on the target environment configuration script. The fourth failure reason may include a test environment deficiency and a test instruction error.

As shown in FIG. 7, when it is determined that the reason of the test failure is a test environment deficiency, for example: when correcting the historical environment configuration script based on the environment requirement differences, the image version in the historical environment configuration script is relatively low, and the environment requirement differences do not indicate an image version difference, therefore, in the test process, the low-version test environment may have poor compatibility with the test instructions in the testing process, resulting in test failure.

In some embodiments, the environment correction agent is used to correct the target environment configuration script based on the fourth failure reason, in response to the fourth failure reason indicating a test environment deficiency.

At this point, the environment correction agent 160 may be used to determine a correction direction based on the fourth failure reason, for example, upgrading the image version. And the installation instructions in the environment configuration script are corrected according to the correction direction, thereby improving compatibility with the test instructions. In the test environment reconstructed according to the target environment configuration script, the test instructions are executed successfully.

It should be noted that the number of installation instructions corrected at this stage is typically very small, and compared with the number of installation instruction correction operations that need to be executed when a test environment is constructed from scratch, the number of installation instruction correction operations is greatly reduced, further improving the efficiency of constructing a valid environment.

Besides a test environment deficiency, the reason of test failure may also be test instruction errors. In some embodiments, the test configuration agent is used to correct the test configuration script based on the fourth failure reason, in response to the fourth failure reason indicating a test instruction error.

As shown in FIG. 7, in the testing phase, the test execution agent 150 may correct the test configuration script based on its own repair capability. In the correction process, in addition to the fourth failure reason, the corrected environment configuration script output by the environment correction agent 160 may also be considered, for example, using the corrected environment configuration script as input to the test execution agent 150 as well, to ensure consistency between the corrected verification logic and the environment configuration logic.

If the maximum number of interaction cycles is reached and the test still fails, the process may return to the planning phase. The test configuration agent 140 is used to determine a correction direction based on the fourth failure reason and correct the erroneous test instructions in the test configuration script.

In the test instruction repair scenario, due to the introduction of the environment reuse mechanism, the number of test instructions requiring correction in similar test environments is far smaller than that in a test environment constructed from scratch, further improving testing efficiency.

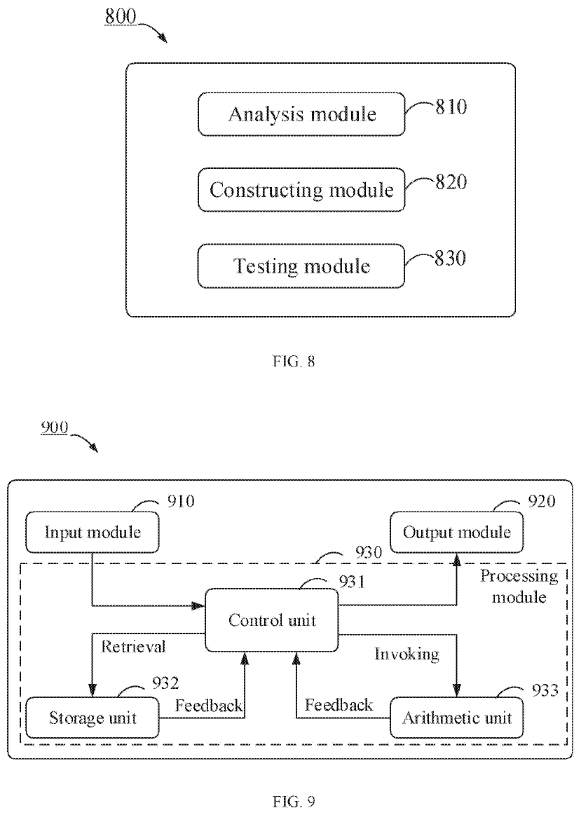

FIG. 8 schematically shows a block diagram of a code testing apparatus according to an embodiment of the present disclosure.

As shown in FIG. 8, the code testing apparatus 800 may include: an analysis module 810, a constructing module 820, and a testing module 830.

The analysis module 810 is used to use an analysis agent to analyze an information of a code to be tested to obtain an environment requirement information, where the environment requirement information indicates a configuration requirement for constructing a test environment for the code to be tested, the configuration requirement matching a programming language of the code to be tested.

The constructing module 820 is used to construct the test environment based on the environment requirement information.

The testing module 830 is used to execute a test on the code to be tested in the test environment to obtain a test result, where the test result indicates a running status of the code to be tested in a valid test environment.

According to embodiments of the present disclosure, the constructing module 820 may include: a first generation submodule and a first constructing submodule.

The first generation submodule is used to generate, using an environment configuration agent, an environment configuration script based on the environment requirement information.

The first constructing submodule is used to construct, using an environment constructing agent, the test environment by running the environment configuration script.

According to embodiments of the present disclosure, the environment configuration script includes a plurality of initial instructions to be executed for constructing the test environment, and the first constructing submodule may include: a first execution unit, a first correction unit, and a first constructing unit.

The first execution unit is used to execute, using the environment constructing agent, the plurality of initial instructions to be executed.

The first correction unit is used to correct, using the environment constructing agent, at least one of the plurality of initial instructions to be executed, in response to detecting that execution of any one of the plurality of initial instructions to be executed fails.

The first constructing unit is used to construct, using the environment constructing agent, the test environment by executing at least one corrected instruction to be executed.

According to embodiments of the present disclosure, the constructing module 820 may further include: a first analysis submodule, a first correction submodule, and a second constructing submodule.

The first analysis submodule is used to perform, using the analysis agent, attribution analysis on a first log of the environment configuration script during runtime of the environment configuration script to obtain a first failure reason, in response to detecting that construction of the test environment fails.

The first correction submodule is used to correct, using the environment configuration agent, the environment configuration script based on the environment requirement information and the first failure reason.

The second constructing submodule is used to construct, using the environment constructing agent, the test environment by running the corrected environment configuration script.

According to embodiments of the present disclosure, the constructing module 820 may further include: a second analysis submodule, a second correction submodule, and a second generation submodule.

The second analysis submodule is used to perform, using the analysis agent, attribution analysis on a second log of the corrected environment configuration script during runtime of the corrected environment configuration script to obtain a second failure reason, in response to detecting that construction of the test environment based on the corrected environment configuration script fails.

The second correction submodule is used to correct, using the analysis agent, the environment requirement information based on the second failure reason and the information of the code to be tested.

The second generation submodule is used to generate, using the environment configuration agent, a to-be-run environment configuration script based on the corrected environment requirement information.

According to embodiments of the present disclosure, the information of the code to be tested includes code structure information; the testing module 830 may include: a third generation submodule and a first execution submodule.

The third generation submodule is used to generate, using a test configuration agent, a test configuration script based on the code structure information and the environment configuration script, where the test configuration script includes a plurality of initial test instructions for the code to be tested, and the plurality of initial test instructions are executed when the test environment is successfully constructed.

The first execution submodule is used to execute, using a test execution agent, the test on the code to be tested in the test environment by running the test configuration script, so as to obtain the test result.

According to embodiments of the present disclosure, the first execution submodule includes: a second execution unit, a second correction unit, and a first testing unit.

The second execution unit is used to execute, using the test execution agent, the plurality of initial test instructions.

The second correction unit is used to correct, using the test execution agent, at least one of the plurality of initial test instructions, in response to detecting that execution of any one of the plurality of initial test instructions fails.

The first testing unit is used to obtain, using the test execution agent, the test result by executing at least one corrected test instruction.

According to embodiments of the present disclosure, the first execution submodule further includes: a first analysis unit, a third correction unit, a first update unit, and a first running unit.

The first analysis unit is used to analyze, using the analysis agent, a third log of the plurality of initial test instructions during runtime of the plurality of initial test instructions to obtain a third failure reason, in response to the test result indicating a test failure.

The third correction unit is used to correct, using the environment configuration agent, the environment configuration script based on the third failure reason, in response to the third failure reason indicating a test environment deficiency.

The first update unit is used to update, using the environment constructing agent, the test environment based on the corrected environment configuration script.

The first running unit is used to run, using the test execution agent, the test configuration script in the updated test environment.

According to embodiments of the present disclosure, the first execution submodule further includes: a first generation unit and a second running unit.

The first generation unit is used to generate, using the test configuration agent, a target test configuration script based on the corrected environment configuration script and the code structure information.

The second running unit is used to run, using the test execution agent, the target test configuration script in the updated test environment.

According to embodiments of the present disclosure, the first execution submodule further includes: a fourth correction unit and a third running unit.

The fourth correction unit is used to correct, using the test configuration agent, the test configuration script based on the third failure reason, in response to the third failure reason indicating a test instruction error.

The third running unit is used to run, using the test execution agent, the corrected test configuration script in the test environment, so as to obtain the test result.

According to embodiments of the present disclosure, the code testing apparatus may further include: an acquisition module, a correction module, and a reconstructing module.

The acquisition module is used to acquire a historical environment configuration script matching the environment requirement information.

The correction module is used to correct the historical environment configuration script to obtain a target environment configuration script matching the environment requirement information.

The reconstructing module is used to construct the test environment based on the target environment configuration script.

According to embodiments of the present disclosure, the correction module may include: a difference analysis submodule and a script correction submodule.

The difference analysis submodule is used to analyze, using the analysis agent, historical code information associated with the historical environment configuration script and the information of the code to be tested, to obtain environment requirement difference information.

The script correction submodule is used to correct, using an environment correction agent, the historical environment configuration script based on the environment requirement difference information to obtain the target environment configuration script.

According to embodiments of the present disclosure, the code testing apparatus may further include: an attribution analysis module and an environment correction module.

The attribution analysis module is used to analyze, using the analysis agent, a fourth log of the code to be tested during runtime of the code to be tested to obtain a fourth failure reason, in response to the test result indicating a test failure.

The environment correction module is used to correct, using the environment correction agent, the target environment configuration script based on the fourth failure reason, in response to the fourth failure reason indicating a test environment deficiency.

According to embodiments of the present disclosure, the code testing apparatus may further include: a configuration correction module used to correct, using the test configuration agent, the test configuration script based on the fourth failure reason, in response to the fourth failure reason indicating a test instruction error.

FIG. 9 schematically shows a block diagram of an agent for code testing according to an embodiment of the present disclosure.

As shown in FIG. 9, in embodiments of the present disclosure, inspired by the Von Neumann architecture in modern computer theory, as shown in FIG. 9, an AI agent 900 may include three core modules: an input module 910, an output module 920, and a processing module 930. The processing module 930 may include a control unit 931, a storage unit 932, and an arithmetic unit 933.

The input module 910 is used for receiving or sensing queries, requests, instructions, signals, data, or other information from the outside world (e.g., users or external environments) and converting them into a format that the AI agent 900 may understand and process. The input module 910 is the primary interface for the AI agent 900 to interact with the outside world, enabling the AI agent 900 to efficiently and accurately obtain necessary “sensory” information from the outside world and respond to such information.

In an example, the input information received by the input module 910 may be the information of the code to be tested as described above.

In an example, the processing module 930 is the core support for the AI agent 900's ability to handle complex tasks. The processing module 930 may determine a target task based on the input information received by the input module 910, determine a large model based on the target task, execute the large model-based code testing method described above by invoking the large model, and output a test result.

In an example, the control unit 931 in the processing module 930 will continuously interact with the storage unit 932, the arithmetic unit 933, and/or the output module 920 during operation. However, it should be noted that in embodiments of the present disclosure, the control unit 931 acts as a single initiator to initiate communication with the storage unit 932, the arithmetic unit 933, and/or the output module 920, while there is no communication coupling between the storage unit 932, the arithmetic unit 933, and the output module 920.

In an example, the performance of the control unit 931 may be closely related to the large model on which the AI agent 900 is based. To fully leverage the capabilities of the large language model, the internal structure of the control unit 931 may be designed to be highly configurable and extensible to handle various types of tasks and requirements in real-world scenarios.

The storage unit 932 may be used for memorizing information such as historical conversations and event streams. The configuration information and target text generated in each previous round, as well as data resources, may be included in the storage unit 932.

In an example, after acquiring a configuration generation request, the AI agent 900 may use an intent recognition model to determine a configuration intent from the initial text. The configuration intent may be stored in the storage unit 932. The AI agent 900 may retrieve relevant data resources from the storage unit 932 and feed them back to the control unit 931. Then, the control unit 931 may use the fed-back data resources to obtain configuration data corresponding to the initial text. It may also retrieve relevant text data from the storage unit 932 and feed it back to the control unit 931. Then, the control unit 931 may use the returned text data to obtain a test result and pass the test result to the output module 920.

The arithmetic unit 933 may be viewed as a predefined tool library. The aforementioned renderers and display controls may be included in the arithmetic unit 933.

In an example, when the AI agent 900 needs to render a plurality of output data, it may call relevant renderers and display controls from the arithmetic unit 933 and feed them back to the control unit 932. Then, the control unit 932 may use the fed-back renderers and display controls to render a first search result and pass the first search result to the output module 920. It can be understood that although large language models have excellent language understanding and generation capabilities, like humans, without any tools, the tasks they may solve are very limited. When the AI agent 900 is endowed with the ability to call tools, it may achieve tasks such as performing mathematical operations with a calculator, performing data analysis with Python, and completing prediction tasks with a search engine.

In an example, the output module 920 may output the test result described above.

The AI agent 900 according to embodiments of the present disclosure may simply and effectively improve the degree of intelligence, as well as enhance flexibility and versatility.

According to embodiments of the present disclosure, the present disclosure further provides an electronic device, a readable storage medium, and a computer program product.

According to embodiments of the present disclosure, an electronic device includes: at least one processor; and a memory communicatively connected to the at least one processor, where the memory stores instructions executable by the at least one processor, and the instructions, when executed by the at least one processor, are used to cause the at least one processor to implement the method described above.

According to embodiments of the present disclosure, a non-transitory computer-readable storage medium having computer instructions therein, where the computer instructions are used to cause a computer to implement the method described above.

According to embodiments of the present disclosure, a computer program product containing a computer program, where the computer program, when executed by a processor, is configured to cause the processor to implement the method described above.

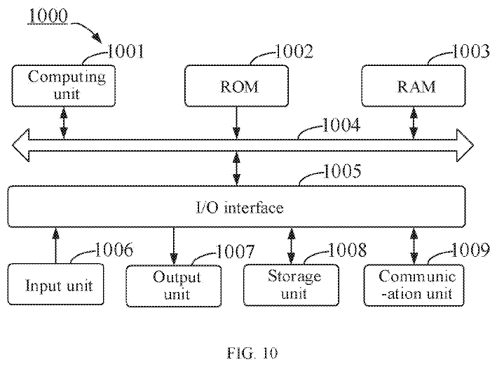

FIG. 10 shows a schematic block diagram of an example electronic device 1000 that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the device 1000 may also be stored. The computing unit 1001, the ROM 1002 and the RAM 1003 are connected to each other through a bus 1004. An input/output (I/O) interface 1005 is also connected to the bus 1004.

A plurality of components in the device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 1001 executes various methods and processes described above, such as the code testing method. For example, in some embodiments, the code testing method may be implemented as a computer software program which is tangibly embodied in a machine-readable medium, such as the storage unit 1008. In some embodiments, the computer program may be partially or entirely loaded and/or installed in the device 1000 via the ROM 1002 and/or the communication unit 1009. The computer program, when loaded in the RAM 1003 and executed by the computing unit 1001, may execute one or more steps in the code testing method described above. Alternatively, in other embodiments, the computing unit 1001 may be used to perform the code testing method by any other suitable means (e.g., by means of firmware).

Various embodiments of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, reason the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM) or a flash memory, an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, an user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server that combines a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be included in the scope of protection of the present disclosure.

What is claimed is:

1. A code testing method, the method comprising:
analyzing, using an analysis agent, an information of a code to be tested to obtain an environment requirement information, wherein the environment requirement information indicates a configuration requirement for constructing a test environment for the code to be tested, the configuration requirement matching a programming language of the code to be tested;
constructing the test environment based on the environment requirement information; and
executing a test on the code to be tested in the test environment to obtain a test result, wherein the test result indicates a running status of the code to be tested in a valid test environment.

2. The method according to claim 1, wherein the constructing the test environment based on the environment requirement information comprises:
generating, using an environment configuration agent, an environment configuration script based on the environment requirement information; and
constructing, using an environment constructing agent, the test environment by running the environment configuration script.

3. The method according to claim 2, wherein the environment configuration script comprises a plurality of initial instructions to be executed for constructing the test environment; and
wherein the constructing, using an environment constructing agent, the test environment by running the environment configuration script comprises:
executing, using the environment constructing agent, the plurality of initial instructions to be executed;
correcting, using the environment constructing agent, at least one of the plurality of initial instructions to be executed, in response to detecting that execution of any one of the plurality of initial instructions to be executed fails; and
constructing, using the environment constructing agent, the test environment by executing at least one corrected instruction to be executed.

4. The method according to claim 2, wherein the constructing, using an environment constructing agent, the test environment by running the environment configuration script further comprises:
performing, using the analysis agent, attribution analysis on a first log of the environment configuration script during runtime of the environment configuration script to obtain a first failure reason, in response to detecting that construction of the test environment fails;
correcting, using the environment configuration agent, the environment configuration script based on the environment requirement information and the first failure reason; and
constructing, using the environment constructing agent, the test environment by running the corrected environment configuration script.

5. The method according to claim 4, wherein the constructing, using an environment constructing agent, the test environment by running the environment configuration script further comprises:
performing, using the analysis agent, attribution analysis on a second log of the corrected environment configuration script during runtime of the corrected environment configuration script to obtain a second failure reason, in response to detecting that construction of the test environment based on the corrected environment configuration script fails;
correcting, using the analysis agent, the environment requirement information based on the second failure reason and the information of the code to be tested; and
generating, using the environment configuration agent, a to-be-run environment configuration script based on the corrected environment requirement information.

6. The method according to claim 1, wherein the information of the code to be tested comprises a code structure information; and
wherein the executing a test on the code to be tested in the test environment to obtain a test result comprises:
generating, using a test configuration agent, a test configuration script based on the code structure information and an environment configuration script, wherein the test configuration script comprises a plurality of initial test instructions for the code to be tested, and the plurality of initial test instructions are executed in response to the test environment being successfully constructed; and
executing, using a test execution agent, the test on the code to be tested in the test environment by running the test configuration script, so as to obtain the test result.

7. The method according to claim 6, wherein the executing, using a test execution agent, a test on the code to be tested in the test environment by running the test configuration script so as to obtain the test result comprises:
executing, using the test execution agent, the plurality of initial test instructions;
correcting, using the test execution agent, at least one of the plurality of initial test instructions, in response to detecting that execution of any one of the plurality of initial test instructions fails; and
obtaining, using the test execution agent, the test result by executing at least one corrected test instruction.

8. The method according to claim 6, wherein the executing, using a test execution agent, a test on the code to be tested in the test environment by running the test configuration script so as to obtain the test result comprises:
analyzing, using the analysis agent, a third log of the plurality of initial test instructions during runtime of the plurality of initial test instructions to obtain a third failure reason, in response to the test result indicating a test failure;
correcting, using an environment configuration agent, the environment configuration script based on the third failure reason, in response to the third failure reason indicating a test environment deficiency;
updating, using the environment constructing agent, the test environment based on the corrected environment configuration script; and
running, using the test execution agent, the test configuration script in the updated test environment.

9. The method according to claim 8, wherein the running, using the test execution agent, the test configuration script in the updated test environment comprises:
generating, using the test configuration agent, a target test configuration script based on the corrected environment configuration script and the code structure information; and
running, using the test execution agent, the target test configuration script in the updated test environment.

10. The method according to claim 8, wherein the executing, using a test execution agent, a test on the code to be tested in the test environment by running the test configuration script so as to obtain the test result further comprises:
correcting, using the test configuration agent, the test configuration script based on the third failure reason, in response to the third failure reason indicating a test instruction error; and
running, using the test execution agent, the corrected test configuration script in the test environment, so as to obtain the test result.

11. The method according to claim 1, further comprising:
acquiring a historical environment configuration script matching the environment requirement information;
correcting the historical environment configuration script to obtain a target environment configuration script matching the environment requirement information; and
constructing the test environment based on the target environment configuration script.

12. The method according to claim 11, wherein the correcting the historical environment configuration script to obtain a target environment configuration script matching the environment requirement information comprises:
analyzing, using the analysis agent, a historical code information associated with the historical environment configuration script and the information of the code to be tested, to obtain an environment requirement difference information; and
correcting, using an environment correction agent, the historical environment configuration script based on the environment requirement difference information to obtain the target environment configuration script.

13. The method according to claim 11, further comprising:
analyzing, using the analysis agent, a fourth log of the code to be tested during runtime of the code to be tested to obtain a fourth failure reason, in response to the test result indicating a test failure; and
correcting, using the environment correction agent, the target environment configuration script based on the fourth failure reason, in response to the fourth failure reason indicating a test environment deficiency.

14. The method according to claim 13, further comprising:
correcting, using a test configuration agent, a test configuration script based on the fourth failure reason, in response to the fourth failure reason indicating a test instruction error.

15. An agent for code testing, comprising:
an input module configured to receive an information of a code to be tested;
a processing module configured to determine a target task based on the information of the code to be tested received by the input module, determine a target large model based on the target task, and execute the method according to claim 1 by invoking the target large model to obtain a test result; and
an output module configured to output the test result obtained by the processing module.

16. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
analyze, using an analysis agent, an information of a code to be tested to obtain an environment requirement information, wherein the environment requirement information indicates a configuration requirement for constructing a test environment for the code to be tested, the configuration requirement matching a programming language of the code to be tested;
construct the test environment based on the environment requirement information; and
execute a test on the code to be tested in the test environment to obtain a test result, wherein the test result indicates a running status of the code to be tested in a valid test environment.

17. The electronic device according to claim 16, wherein the instructions are further configured to cause the at least one processor to at least:
generate, using an environment configuration agent, an environment configuration script based on the environment requirement information; and
construct, using an environment constructing agent, the test environment by running the environment configuration script.

18. The electronic device according to claim 17, wherein the environment configuration script comprises a plurality of initial instructions to be executed for constructing the test environment; and
wherein the instructions are further configured to cause the at least one processor to at least:
execute, using the environment constructing agent, the plurality of initial instructions to be executed;
correct, using the environment constructing agent, at least one of the plurality of initial instructions to be executed, in response to detecting that execution of any one of the plurality of initial instructions to be executed fails; and
construct, using the environment constructing agent, the test environment by executing at least one corrected instruction to be executed.

19. The electronic device according to claim 17, wherein the instructions are further configured to cause the at least one processor to at least:
perform, using the analysis agent, attribution analysis on a first log of the environment configuration script during runtime of the environment configuration script to obtain a first failure reason, in response to detecting that construction of the test environment fails;
correct, using the environment configuration agent, the environment configuration script based on the environment requirement information and the first failure reason; and
construct, using the environment constructing agent, the test environment by running the corrected environment configuration script.

20. A non-transitory computer-readable storage medium having computer instructions therein, wherein the computer instructions are configured to cause a computer to at least:
analyze, using an analysis agent, an information of a code to be tested to obtain an environment requirement information, wherein the environment requirement information indicates a configuration requirement for constructing a test environment for the code to be tested, the configuration requirement matching a programming language of the code to be tested;
construct the test environment based on the environment requirement information; and
execute a test on the code to be tested in the test environment to obtain a test result, wherein the test result indicates a running status of the code to be tested in a valid test environment.
